(19) United States
(12) Patent Application Publication
(10) Pub. No.: US 2023/0177404 A1
(43) Pub. Date: Jun. 8, 2023

(54) ADAPTIVE MODEL PRUNING TO IMPROVE PERFORMANCE OF FEDERATED LEARNING

(71) Applicant: FORD GLOBAL TECHNOLOGIES, LLC, Dearborn, MI (US)

(72) Inventors: Zaydoun Rawashdeh, Farmington Hills MI, MI (US); Harsh Bhupendra Bhate, Dearborn, MI (US); Jin Lu, Northville, MI (US)

(21) Appl. No.: 17/544,307

(22) Filed: Dec. 7, 2021

(51) Int. Cl. G06N 20/20

(52) U.S. Cl. CPC G06N 20/20

(57) ABSTRACT

A system receives a plurality of data sets relating to differently trained versions of a global machine learning model, from a plurality of vehicles, the data sets including at least a present local loss value experienced by a current version of the global model executing on a given vehicle for which a data set of the plurality of data sets was received. The system determines a loss reduction for each received data set, representing a loss reduction since a previous local loss value included in a previous received data set corresponding to the given vehicle. The system determines whether the loss reduction for each received data set of the plurality of data sets exceeds a predefined threshold cutoff value and trains the global model using federated learning and based on the data sets of the plurality of data sets for which the loss reduction exceeds the predefined cutoff value.

### TECHNICAL FIELD

The illustrative embodiments generally relate to adaptive model pruning to improve performance of federated learning.

### BACKGROUND

Onboard vehicle software is constantly improving in scope and functionality. Historically, this software has been built and developed by versioning, wherein coders improve future versions of software and deploy updated versions. Machine learning, however, allows for software to self-improve without the requirement of a coder actually changing how the software operates.

Machine learning models often utilize large data sets gathered from thousands of sources. This training data can be used to train a central model, which can be redistributed to clients as an improved model. In some instances, there may be deployed models that are capable of independent learning, i.e., they begin to branch from the base deployed model. This provides an opportunity for federated learning, which allows for using the weights and biases of differently trained models to improve a centralized model. This avoids the overhead of transferring all the data observed by all the entities, and instead essentially allows the individual entities to transfer what their models have “learned,” as information to be used to update the global model.

### SUMMARY

In a first illustrative embodiment, a system includes a processor configured to receive a plurality of data sets relating to differently trained versions of a global machine learning model, from a plurality of vehicles, the data sets including at least a present local loss value experienced by a current version of the global model executing on a given vehicle for which a data set of the plurality of data sets was received. The processor is also configured to determine a loss reduction for each received data set of the plurality of data sets, representing a loss reduction since a previous local loss value included in a previous received data set corresponding to the given vehicle. The processor is further configured to determine whether the loss reduction for each received data set of the plurality of data sets exceeds a predefined threshold cutoff value and train the global model using federated learning and based on the data sets of the plurality of data sets for which the loss reduction exceeds the predefined cutoff value.

In a second illustrative embodiment, a method includes receiving a plurality of data sets relating to differently trained versions of a global machine learning model, from a plurality of vehicles, the data sets including at least a present local loss value experienced by a current version of the global model executing on a given vehicle for which a data set of the plurality of data sets was received. The method further includes determining a loss reduction for each received data set of the plurality of data sets, representing a loss reduction since a previous local loss value included in a previous received data set corresponding to the given vehicle. Also, the method includes determining whether the loss reduction for each received data set of the plurality of data sets exceeds a predefined threshold cutoff value and training the global model using federated learning and based on the data sets of the plurality of data sets for which the loss reduction exceeds the predefined cutoff value.

In a third illustrative embodiment, a non-transitory storage medium, stores instructions that, when executed by one or more processors, cause the one or more processors to perform a method that includes receiving a plurality of data sets relating to differently trained versions of a global machine learning model, from a plurality of vehicles, the data sets including at least a present local loss value experienced by a current version of the global model executing on a given vehicle for which a data set of the plurality of data sets was received. The method further includes determining a loss reduction for each received data set of the plurality of data sets, representing a loss reduction since a previous local loss value included in a previous received data set corresponding to the given vehicle. Also, the method includes determining whether the loss reduction for each received data set of the plurality of data sets exceeds a predefined threshold cutoff value and training the global model using federated learning and based on the data sets of the plurality of data sets for which the loss reduction exceeds the predefined cutoff value.

### BRIEF DESCRIPTION OF THE DRAWINGS

FIG. 1 shows an illustrative example of a multi-vehicle system capable of in-vehicle and federated learning;

FIG. 2 shows an illustrative example of a learning process for a deployed model that may occur onboard a vehicle; and

FIG. 3 shows an illustrative example of an analysis, training and pruning process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Such processors may be described individually or collectively and it is appreciated that because processors can work alone or in conjunction, use of multiple processors to perform actions ascribed to one processor is not outside the scope of such description or language. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system (or systems acting in conjunction) is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In a vehicle network with millions of vehicles, each observing large data sets and having discretely trained models, the massive number of alternative models and alternative observations provides an opportunity for federated learning. At the same time, many of the models may not have diverged significantly since a last update, and thus may not represent good candidates for training a central model. Adding in all the weights and biases of these models may delay the convergence of the central model with better-trained models. The illustrative embodiments propose a pruning process, wherein usages of a given model can be specified based on whether the model meets parameters for being a good candidate, and thus the model set used to train the global model can be expected to include candidates that represent good candidates for model training. Model pruning can also reduce computational overhead and communication overhead at the clients.

In one example, the pruning decisions are made at a server and all clients share a loss value with the server and if the loss reduction over a cycle (or cycles) is not above a cutoff threshold parameter, then the data for that client may be masked out, as it does not represent a good candidate for training. Models with high loss reduction appear to have learned significantly since a prior iteration, whereas models with low loss reduction are converging on a state where learning has slowed or stalled for those models, and they are limited in their current improvement.

The threshold may initially be set to a high standard (e.g., very high loss reduction), as many models will likely have some early degree of loss reduction, and so the standard would have to be sufficient to still prune out some of those models. As the other models improve, their loss reduction will begin to converge with the already-pruned models loss reduction, and so a new standard may need to be chosen that does not result in over-pruning, but still isolates some of the models for pruning. If a threshold for masking out model weights is set too high, it may be apparent based on the number or percentage of remaining unpruned models being too low, and the standard can be modified to include more models.

Moreover, with millions of vehicles reporting model weights, it may be reasonable to contemplate a reporting cycle as being sufficiently ended when a certain number or percent of vehicles have reported. Some vehicles may be offline for months, others may have limited connectivity and thus limited reporting, and waiting for all vehicles in a set to report may be inefficient, provided at least a suitable number of vehicles have reported to make the training meaningful. Thus, the pruning could be applied to the data set as reported for the cycle (or a random sampling of reporting vehicles). Of course, the non-reporting vehicles could potentially have the most interesting and useful models, and so training could be delayed until there is one hundred percent reporting, but the statistical likelihood of non-reporting vehicles having the best models, or even a significantly different good/bad model distribution from the group, is reasonably low and, unless observed to be otherwise, it is not an unreasonable approach to take a very large subset sample of a very, very large group and consider that sample to be sufficiently useful and/or representative for training.

Federated Learning (FL) is one type of distributed learning used to build more accurate machine learning models. Using FL concept, machine learning prediction model can be optimized without exposing the raw data of each client (worker). Instead, clients train their models locally and share the learned weights (or weights' difference between consecutive runs) of models with the cloud for aggregation. On the cloud, a FL server aggregates (e.g., averages) all received weights from the clients, creates a global model and sends it back to the clients. This process repeats until the model reaches the desired performance.

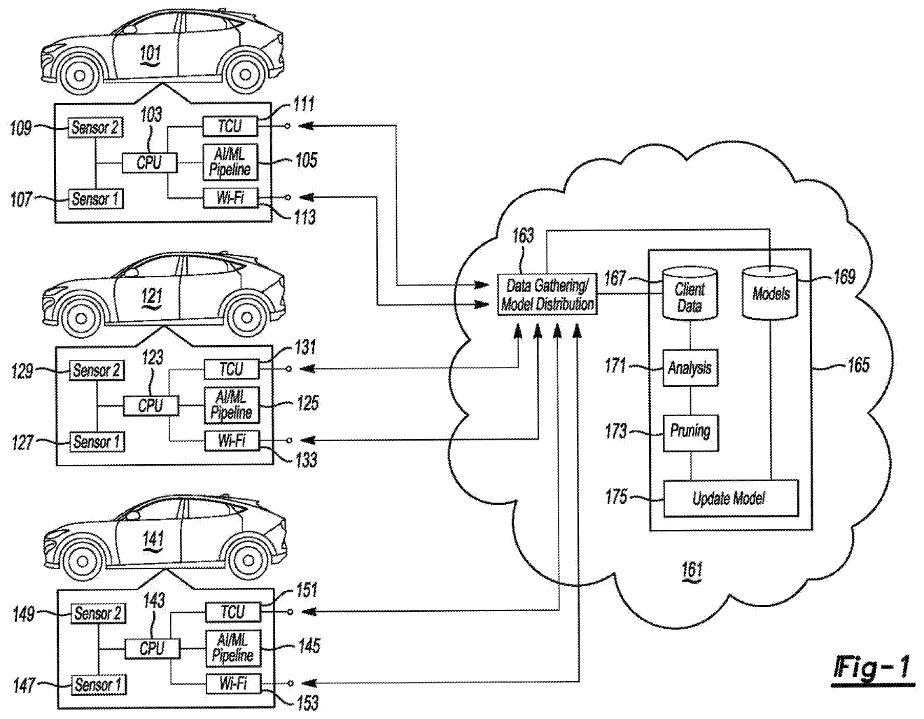

FIG. 1 shows an illustrative example of a multi-vehicle system capable of in-vehicle (online) learning and federated learning. A limited subset of illustrative vehicles 101, 121, 141 is shown, each having an onboard computing system capable of data gathering and capable of running in-vehicle learning (machine learning occurring on the vehicle). While the computing systems are presented as comparable, certain vehicles may have additional or alternative versions of sensors or features capable of gathering data and/or user interaction. Thus, the same model deployed on two vehicles may have access to input gathered from differing sensors (e.g., of varied precision or quality). Further, each vehicle 101, 121, 141 may be operating in varied environments and this, along with user settings, may cause certain vehicles to gather more or different data from other vehicles. Also, each vehicle may be used with differing frequency, resulting is disparity in size of data contemplated as well. For all these reasons and more, the models executing on the vehicles, and trained on the vehicles, may experience very different training and changes, in terms of both frequency of training and loss reduction.

In this example, each vehicle has a plurality of sensors 107, 109, 127, 129, 147, 149, deployed to vehicles 101, 121, 141 respectively (two per each in this example). These sensors gather data for machine learning processes and for training, for example, one sensor may be a camera and the other may be an accelerometer, and the data gathered may be an image occurring during acceleration and the image may be labeled with acceleration data.

A machine learning process may provide a feature to the user based on the gathered data, and a configuration file onboard the vehicle, and associated with the machine learning process, may defined expectations for the process. The process may be part of an AI/ML operations pipeline 105, 125, 145, wherein the vehicle monitors models, provides inferences for model usage and model training, gathers data, labels data, trains models and validates newly trained models.

Generally speaking, the vehicle 101 may determine, based on a monitoring process of the pipeline 105, in this example, and executed by one or more vehicle processors 103, that a model stored onboard the vehicle 101 is ready for training. Using data gathered by sensors 107, 109, and/or predesignated training data, the vehicle 101 may train the model onboard the vehicle 101,

The newly trained model can be stored onboard the vehicle in a model repository, and executed in the background as shadow software during vehicle operation for verification purposes. The shadow execution will not necessarily produce any results onboard the vehicle (as the foreground model would), but it still provides outputs which can be checked against expectations defined in the configuration file and checked against a foreground execution of the model. If the model shows sufficient improvement (which can also be defined by the configuration file), then the newly trained model can replace the foreground model as the active model.

At that point, the vehicle 101 is likely executing a different model from vehicles 121 and 141, unless the models on the other vehicles 121, 141 had been trained exactly the same (onboard those respective vehicles) and had changed exactly the same. As each vehicle completes a training cycle and validates a model, it may report the results of the training to the cloud 161. Since vehicles may train at different rates, as previously noted, it may be reasonable to attempt federated learning at the cloud 161 when a threshold number of model training weights and loss values have been reported.

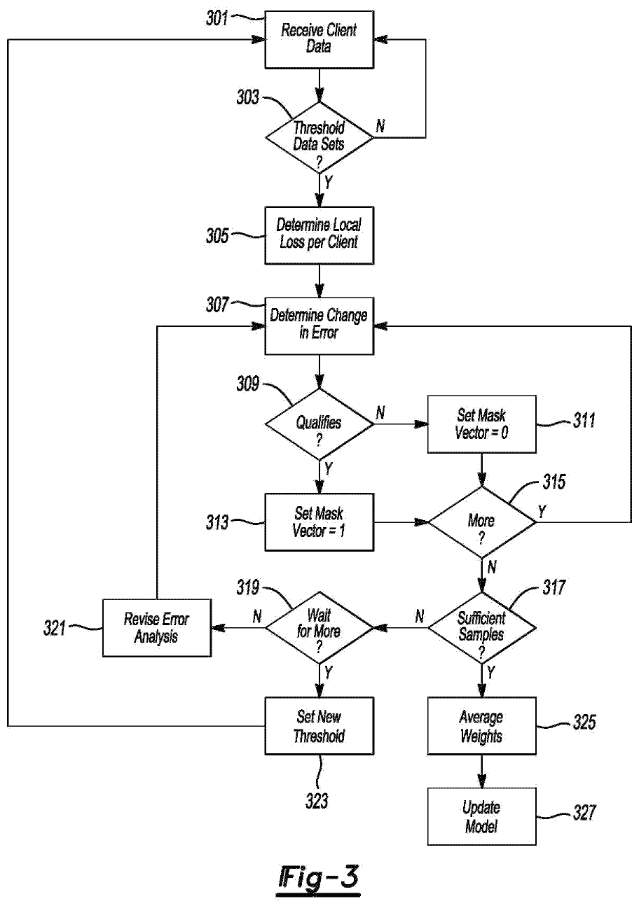

A gateway function 163 can provide for incoming data handling and model distribution (distributing a model newly trained through federated learning). Client data from the individual vehicles may be stored in database 167 and model weights and other values may be stored in model data repository 169. An analysis process 171 may execute when sufficient reporting of model updates has occurred, and may analyze the data sets to determine which models to prune, described in greater detail in conjunction with FIG. 3. After pruning 173 certain models from the training models (exempting their weights from consideration), the cloud process may use federated learning to update the global model at 175. The gateway (or another function) 163 can then distribute the updated global model to vehicles 101, 121, 141 as appropriate.

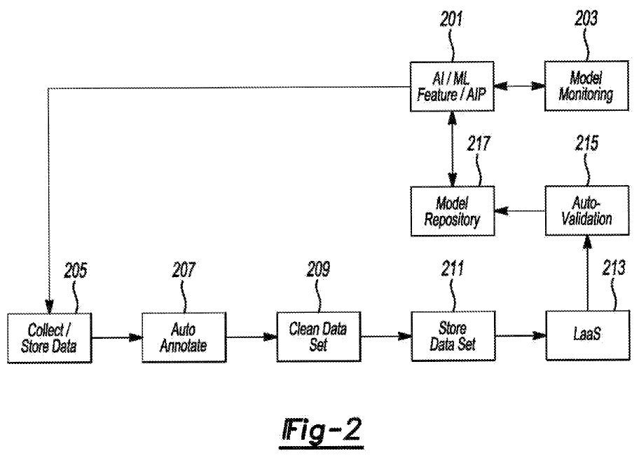

FIG. 2 shows an illustrative example of a learning process for a deployed model that may occur onboard a vehicle. This process contemplates in-vehicle learning (online learning) and may be used in support of federated learning by locally training models that can be reported to a central entity for federated learning. Model repositories on a vehicle may store both personal and generic model versions, and personal model versions trained on a vehicle for a specific person may not be suitable for global model training in the cloud, if they are tailored to a given user or group of users. Cloud model repositories may store versions of global and archetype models, and/or may store versions of models applicable to individual users or vehicles with corresponding reference to the applicable entity.

Federated learning may also be achieved in-vehicle or at an edge node, as vehicles can exchange loss information and weights relating to commonly possessed models, and certain of those models may be trainable in a federated manner (using information from other vehicles) in a given vehicle, if the models from the other vehicles represent sufficient loss reduction and/or generally indicate that they have “learned” better than the version of the model currently residing on the given vehicle. The sharing vehicles may report a cycle associated with a plurality of loss values so that loss reduction relative to the given object vehicle can be determined—this can include duration between loss values, data points contemplated, operating hours between loss values, etc. The given object vehicle can then compare loss reduction to its own loss reduction over a comparable span, and once sufficient shared models representing “better” loss reduction have been received, the given vehicle can train its own model using federated averaging of the weights associated with the faster-learning models, shared by the other vehicles.

Techniques and concepts described with respect to in-vehicle learning may also be applicable to federated learning where reasonable, and a skilled artisan will understand when the concepts disclosed as pertaining to one would be extendable to the other.

An AI/ML feature 201 may represent the presently executing version of a given ML model, which may have a configuration file that defines its own requests and parameters for data gathering. This model may have originally been distributed as a global model and/or a global model trained through a prior federated learning iteration. The vehicle 100 can provide localized data pursuant to gathering requests, collecting any permissible data requested 203 at any interval over which the data is requested. Policy management can dictate how much data is stored for a given model or service, since memory is not limitless, but each model 201 can have a localized version of data gathered and annotated according to its own parameters, so that highly specific versions of the same general types of data may be stored for each model's training.

An automatic annotation/labeling process 205 can serve to label the data in real-time, allowing for immediate use of the data without having to wait for a manual labeling process to occur. This adds relevance, from the perspective of the given feature 201, to the data, producing a clean data set 207 which can be stored 209 with respect to the given feature 201. This data can be replaced by newer data or retained as long as needed and/or policy permits.

Learning as a Service (LaaS) 211 can provide in-vehicle learning without recourse to cloud or edge computing if desired. This allows the vehicle 100 to self-improve its own models without having to wait for global improvement or deployment. This also allows for leveraging HPCC and targeted architecture of the vehicle 100 to train a model efficiently using vehicle 100 architecture and distributes the computing that would be used to train a model over the vast fleet of deployed vehicles. The results of this training, when applied to appropriate models that benefit from federated learning, can be shared with a central training platform (e.g., the cloud/backend) and these results of localized in-vehicle training can be used to retrain the global model in federated learning.

A newly trained model can be validated 213 against a set of parameters to ensure general functionality, as well as to determine if the model represents an improved version of the current model 201. Once validated, the model can be moved to a model repository, which can track deployed global models and store past iterations/version of models. In federated learning, globally trained models may be validated in the cloud prior to distribution or may be distributed to a limited subset of vehicles for testing/validation prior to wide distribution.

The in-vehicle training process allows for vehicles to self-improve their own models using data that is relevant to both the model and to the given vehicle. Because vehicles will observe significantly varied information, based on localities, overall usage, specific types of usage, owner/operator tendencies, environmental variances, etc., the experience of a given vehicle is much less homogeneous than, for example, that of an application residing on a desktop computer in a fixed location in an office environment. While any deployed model may vary in usage based on operator tendencies and goals, vehicles themselves represent continually variable operating environments and may require many additional variances over a typical model to ensure continued improvement and performance under a much wider variable set. This is not to say that vehicle deployed models will not benefit from global updates, but in some instances they will also benefit from a variety of personal improvements in a manner that may be reflective of a much more custom environment relative to a given vehicle than a simple improvement of a model that is trained relative to one type of user (common goals and usage) versus another. Whether or not a given model is suitable for federated learning may depend on how personal the model is—e.g., a window location preference model may generally be very personal, but there may also be some default regional settings that could benefit from federated learning from models across the region. In such an example, there may be a baseline model distributed with new vehicles that is trained based on regionally observed predictions and preferences, and then the model quickly becomes personalized through in-vehicle training and is no longer subjected to updates from the centrally trained model. At the same time, that model may still be used to train the central model which serves as the baseline distribution model for vehicles that have not yet been personalized to an owner.

The model repository may exist in both the cloud and in the vehicle. The cloud version of the repository may store generic and archetype models, which may be ML models that are widely applicable to a fleet, region, environment, etc. Both the cloud and vehicle may store specialized models, which are ML models that are unique to a given user or vehicle/VIN. These are models that may have been trained specifically for that user or vehicle. This could literally represent tens of millions of models in the cloud, and may need to be accommodated in a reasonable data management fashion. Generally speaking, the generic models may benefit from fleet-wide federated learning, the archetype models may benefit from federated learning within their distribution region (smaller fleet, region, environment, etc.) and the personal models will usually not be subjects of federated learning. At the same time, exceptions may exist and will be appreciated by a skilled artisan where appropriate.

Sources of the model training can be both in-vehicle (for specialized models, for example) and federated learning (for global models, for example). Data stored with respect to a given model may include, for example, but is not limited to, descriptions of models, algorithm classes (e.g. linear regression, decision tree, neural network, etc.), ML frameworks, contact information for model/feature owners, versions of training datasets used to achieve the model, vehicle dependencies, deployment modes, dependencies, activation triggers, etc.

The cloud 161 may be configured to deliver updated models, such as when a new ML model reaches a specific branch in the model repository. For a given model, updates may also be scheduled for vehicles that may benefit from an identified version change between a deployed model and a newly trained model. Other delivery triggers may include one-click deployment (instantaneous) or be based on vehicle and/or lifecycle events. For example, a valid vehicle state may be required before deployment, which can include, but is not limited to, subscription/enrollment, vehicle authorization, user authorization, certain software or hardware features being or not being present, etc.

Model Versioning is a process that may be associated with any AI/ML infrastructure. With the illustrative FNV AI/ML Architecture, the concepts of in-vehicle learning and federated learning may benefit from modified model versioning in the vehicle to keep track of models that are trained, finetuned, validated and updated in the vehicle. In the automotive context, this may include a storage structure that works with AUTOSAR, however it is appreciated that this concept extends beyond the automotive context to any group of disparately trained models that can report to a central designee designated to train the global model through federated learning.

Models may be divided in two categories: general models, or specialized models. General models represent a model applicable to a large fleet of a vehicles, e.g., all vehicles of particular model or all vehicles in particular region. Those models may be provided by cloud and trained in the cloud (even e.g., through federated learning) and provided to a vehicle as part of normal software/configuration load. Specialized models are models trained for a particular user or a particular vehicle. They may not be a part of software load and can be trained either in vehicle or in cloud. Specialized models are typically derived from architype non-specialized models.

Models may also need to be validated before deployment, which can include aggressive testing under a variety of circumstances that help ensure that a given vehicle will not behave unexpectedly under a very broad range of circumstances. Before a model is deployed to a production environment, the model may be deployed with supporting inference code to a cloud environment. There, test data and validation/threshold data can be used in conjunction with the model to ensure that expected results/thresholds are being achieved under execution of the test data. If the model is a new version of an existing model, differential testing may be used, which can compare the differences in execution from one version to another when the inputs (data) are the same.

Additionally, as previously noted, there may be a shadow mode of the model that can be executed in the target environment without changing performance of the presently executing model. This allows for prediction relative to both the existing and new version of the model. Using live data, prediction inputs and outputs can be monitored for both versions and saved, and the resulting data can be used to determine if the new version is functioning better than the existing version, which may serve as a deployment trigger. In the context of federated learning, shadow execution may occur on a random subset of vehicles to ensure consistency of operation and output under random distribution prior to global distribution of the newly trained model.

FIG. 3 shows an illustrative example of an analysis, training and pruning process. As noted before, this process relates to federated learning (FL), wherein weights of many models that have branched from an initial model are used to retrain the initial (or a previously trained) version of the global model, leveraging the training occurring onboard some or all of the remote entities that are individually training the model.

Any FL platform may provide a secure compute framework to support FL needs. It may implement a secure communication protocols, using different encryption methods, while supporting FL architectures and secure computation of various machine learning algorithms, including all the gradient-based machine learning models (e.g., generalized linear models, gradient boosting decision tree algorithms, deep learning).

The illustrative embodiments contemplate an adaptive pruning method that finds an optimal, or sufficient, set of remaining (i.e., not pruned) model parameters for the most efficient training in the near future. The method prunes clients based on their individual training progress between different rounds of training. Models (clients) with significant change (e.g., high loss reduction) between runs are the ones that may be primarily considered for the future global model updates. This means the model enhanced from the previous run and would have more effect on the global model. Models with less significant change should be pruned. It is worth noting that even if a model is pruned because it has a low loss reduction, the pruning does not necessarily persist, and the performance and loss reduction of the model can be contemplated in future reporting cycles and the model can be added back to the data set of usable models for training.

An example includes a FL system with N clients. Each client n ∈ [N]:={1, 2, . . . , N} has an empirical error (local loss)

$${F}_{n} ( w ) := \frac{1}{\vert {D}_{n} \vert} {\sum }_{i ∈ {D}_{n}} {f}_{i} ( w ) \qquad [ 1 ]$$

defined on its local dataset Dn for model parameter vector w, where fᵢ(w) is the loss function (e.g., cross-entropy, mean square error, etc.) that captures the difference between the model output and the desired output of data sample i. The system tries to find a parameter w that minimizes the Empirical error (global Error):

$${min}_{w} F ( w ) := {\sum }_{n ∈ [ N ]} {p}_{n} {F}_{n} ( w ) \qquad [ 2 ]$$

where pₙ>0 are weights per clients (different from the weights of the model) such that P_{n∈[N]}pₙ=1. For example, if Dₙ ∩D_{n′}=ø for n≠n′ and set pₙ=Dₙ/|D| with D:=∪Dₙ, we have

$$F ( w ) := \frac{1}{\vert D \vert} {\sum }_{i ∈ {D}_{n}} {f}_{i} ( w ) . \qquad [ 3 ]$$

Other ways of configuring pₙ may also be used to account for fairness. The FL procedure usually involves multiple stochastic gradient descent (SGD) steps on the empirical error (local loss) Fₙ (w) computed by client n, followed by a parameter fusion step that involves the server collecting clients' local parameters and computing an aggregated parameter. In Federated Averaging, the aggregated parameter is simply the average of local parameters weighted by pₙ. In the following, we call this procedure of multiple local SGD steps followed by a fusion step a round. It is possible that each round only involves a subset of clients, to avoid excessive delay caused by waiting for all the clients. It has been shown that Federated Averaging converges even with random client participation, although the convergence rate is related to the degree of such randomness.

In the edge/mobile computing environment where clients' resources and communication bandwidth are limited, the above FL procedure may be significantly challenged when the model size is large. Model pruning may help reduce the computation and communication overhead at clients.

In the beginning of an FL process, a pre-trained model (called a baseline global model) is distributed by the server to all clients. The adaptive pruning is performed with the standard Federated Averaging procedure, where the model can either grow or shrink depending on which way makes the training most efficient. In this stage, data from all participating clients are involved.

In an example of adaptive pruning method, the notion of pruning broadly includes both removing and adding back local parameter updates. Hence, such pruning operations are collectively called reconfiguration. The model is reconfigured at a given interval that includes multiple iterations. For pruning, reconfiguration takes place at the server after receiving parameter updates from clients (i.e., at the boundary between two FL rounds), thus the reconfiguration interval in this case is an integer multiple of the number of local iterations in each FL round. In each reconfiguration step, adaptive pruning finds an optimal or sufficient set of remaining (i.e., not pruned) model parameters for the most efficient training in the near future. Then, the parameters are pruned or added back accordingly, and the resulting model is used for training until the next reconfiguration step.

This pruning assists in determining a subnetwork that learns the fastest or at least faster than the full network of clients, many of which may experience minimal loss reduction between rounds for a variety of reasons. One example of how this can be achieved is by estimating the empirical error divided by the time required for completing an FL round, for any given subset of parameters chosen to be pruned. Note that after parameter averaging in FL, all clients start with the same parameter vector w. Hence, this example investigates the change of empirical error (local loss) after one SGD iteration starting with a common parameter w(k) in iteration k. The idea is that, if there is a significant change in the loss (equivalently the accuracy), then a given model is a good candidate and has the credibility to update the final global model.

Let g_{w}(k) denote the stochastic gradient evaluated at w(k) and computed on the full parameter space in iteration k, such that E[g_{w}(k)]=∇F(w(k)). Also, let m_{w}(k) denote a mask vector that is zero if the corresponding local update w(k) is pruned and one if not pruned. When the model is pruned at the end of iteration k, parameter update in the next iteration will be done on the pruned parameter (clients) vector, w′(k), so we have an SGD update step that follows:

w(k+1)=w′(k)−ηΣ_{w}′g_{w′}(k)m_{w′}(k) [4]

In order to calculate the mask vector, hence perform client pruning, it is assumed that all clients share their loss values with the server. Assume that the server updates the mask vector every δ iterations and assume that the loss value for client n calculated at cycle k-δ using equation 1 is Fₙ^{k-δ}(w). Assume that the loss value calculated at current cycle k, is Fₙ^{k}(w), then loss value reduction:

$${Loss}_{red} = \frac{{F}_{n}^{k} ( w ) - {F}_{n}^{k - δ} ( w )}{δ} \qquad [ 5 ]$$

The corresponding scalar value, m_{c}, for client n in the mask vector, M, is defined as follows:

$${m}_{c} = \{ \begin{matrix}0 & if {Loss}_{red} < γ \\ 1 & otherwise\end{matrix} \qquad [ 6 ]$$

Where γ is a predefined threshold. Hence, clients with m_{c} are pruned, and their weights will not be used to update the global model. The steps take place on the server after receiving models and loss values from the clients, which means the weights of the model will not change. Gamma may be modified dynamically if insufficient models are being pruned and/or over-pruning is occurring. The idea is to set gamma at a value that prunes models that have not learned as fast relative to the larger group, so that a subset of reporting models that represent the faster learners is used to update the global model. At the same time, there may be a desire to maintain a certain size or percentage of included weights.

In the example shown in FIG. 3, the cloud 161 receives the data at 301 from a plurality of reporting vehicle 101, 121, 141, including the loss values and model weights for a given interation of the model on a given vehicle. Once there are a threshold number of data sets at 303 (which could be all data sets, e.g., all vehicles, but does not necessarily have to be all data sets), the process examines the loss for each client at 305 and determines the loss reduction (change in loss over the number of cycles, for example) at 307. The process also determines whether the client qualifies for inclusion in training at 309, which in this case is a comparison of the loss reduction to whatever value is set for gamma.

In an alternative example, the server may distribute the gamma value or preferred gamma value for a given cycle to the candidate vehicles, and the candidate vehicles can determine their own loss reduction over an appropriate number of cycles. Vehicles that do not have sufficient loss reduction can skip the step of reporting their weights and model data, to further reduce transfer overhead. The appropriate number of cycles may be, for example, a number of cycles since a last upload, over a time period, etc. It may also vary per vehicle (if a cycle represents a training instance), but if the loss reduction is averaged per cycle then the vehicle may be able to self-determine a relative value to other vehicles.

In another instance, there may be a threshold loss reduction over any one cycle that causes reporting as well, if the vehicle is self electing not to report. This same concept may apply to server decisions about pruning. That is, a vehicle may experience very significant loss reduction over a single cycle, and then (being near optimal, for example), may experience reduced loss reduction. If the number of cycles is large enough, it can mitigate the effect of the one-off loss reduction, but the weights for the model may still be relevant as the model learned “very fast” over a given training cycle. That model may still qualify for inclusion under certain circumstances, if the max reduction over a single cycle is above a threshold and assuming that the implementor considers this to be a valuable indicator. For similar reasons, the number of cycles used for determining the loss reduction relative to gamma may be vehicle specific, if the vehicle is vetting the data, so that a large number of vehicles having multiple-cycle reporting do not cause a vehicle undergoing only a single cycle of training to under-value its loss reduction by dividing it by the larger number of training cycles (ad hence, reporting cycles) experienced by the group as a whole.

If a given data set qualifies for inclusion at 309, the mask vector is set to 1 at 313, otherwise the vector is set to 0 at 311. This is simply a multiplication coefficient applied to the resulting weights to determine if a weight set is included or zeroed out. If additional data sets remain at 315, the analysis repeats until all relevant data sets have been evaluated for pruning.

Once the data sets have been pruned based on the present value of gamma, the process may evaluate whether the resulting number or percentage of data sets is sufficient at 317, e.g., if it meets a predefined parameter for training. If the number is not, the process may either elect to wait for more data sets at 319 or set a new threshold at 321. For example, if the training was attempted when there was only 50 percent reporting, and gamma proved to be too aggressive to produce a sufficient number of non-pruned data sets, the process may elect to simply wait for more reporting, as additional data may result in the appropriate number of data sets. On the other hand, if 95 percent of vehicles had reported, gamma may need to be adjusted to re-include some previously pruned data sets. The decision about which path (if either path is an option) may be taken may also be relative to the expected distribution of successful values across remaining possible reporting.

For example, if 100 total vehicles were expected to report, and the threshold desired data set size was 30, analysis at 50 percent reporting might indicate that 20 models were not pruned. The projected results from the remaining 50 percent would be another 20 models, and so the process may elect to wait, as the goal of 30 models to be included should be achieved around 75 percent reporting. At the same time, if the analysis at 50 percent reporting revealed that only 10 models demonstrated sufficient loss reduction, then the expectation would be that approximately 20 models would demonstrate sufficient loss reduction at full reporting, and so gamma may then need to be adjusted. Adjustment of gamma can even be a function of the present subset of reporting vehicles—e.g., gamma may be adjusted based on the loss reduction of the 50 percent reporting to include, for example 18 vehicles, setting an expectation that the full data set would be achieved around 83 percent reporting. Alternatively, gamma may simply be adjusted downward, and, in the example, if model updating were desired at 50 percent reporting, then gamma may be downwardly adjusted until it includes 30 of the 50 reporting vehicles.

Once sufficient models have been elected at 317, federated averaging can be used at 325 to average the weights of the models that learned the most and this data can be used to update the global model at 327. Even when updated, the global model could be bench tested and/or distributed to a limited subset of vehicles prior to wide distribution, in order to validate the newly trained version of the model.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A system comprising:
a processor configured to:
receive a plurality of data sets relating to differently trained versions of a global machine learning model, from a plurality of vehicles, the data sets including at least a present local loss value experienced by a current version of the global model executing on a given vehicle for which a data set of the plurality of data sets was received;
determine a loss reduction for each received data set of the plurality of data sets, representing a loss reduction since a previous local loss value included in a previous received data set corresponding to the given vehicle;
determine whether the loss reduction for each received data set of the plurality of data sets exceeds a predefined threshold cutoff value; and
train the global model using federated learning and based on the data sets of the plurality of data sets for which the loss reduction exceeds the predefined cutoff value.

2. The system of claim 1, wherein the loss reduction is an average loss reduction over a plurality of reporting cycles, wherein a reporting cycle represents an iteration of the data set, including the present local loss value, received for the given vehicle.

3. The system of claim 1, wherein the processor is further configured to:
set a mask vector for each vehicle of the plurality of vehicles for which the loss reduction does not exceed the predefined cutoff value; and
wherein the training is based on the received plurality of data sets modified by the mask vector, such that data sets from each vehicle for which the loss reduction does not exceed the predefined cutoff value are masked out when training the global model.

4. The system of claim 1, wherein the processor is configured to wait for all of the plurality of vehicles to complete at least one reporting cycle since a prior reporting cycle before training the global model, wherein a reporting cycle represents an iteration of the data set, including the present local loss value, received for the given vehicle.

5. The system of claim 1, wherein the processor is configured to wait for at least one of a predefined total number or percentage of the plurality of vehicles to complete at least one reporting cycle since a prior reporting cycle before training the global model, wherein a reporting cycle represents an iteration of the data set, including the present local loss value, received for the given vehicle.

6. The system of claim 5, wherein the processor is further configured to:
determine whether at least one of a total number or percentage of vehicles for which the loss reduction exceeds the predefined threshold cutoff value exceeds a predefined value representing sufficient training data; and
responsive to the at least one of the total number or percentage not exceeding the predefined value, wait for data sets to be received from an additional number or additional percentage of the plurality of vehicles.

7. The system of claim 1, wherein the processor is further configured to:
determine whether at least one of a total number or percentage of vehicles for which the loss reduction exceeds the predefined threshold cutoff value exceeds a predefined value representing sufficient training data; and
responsive to the at least one of the total number or percentage not exceeding the predefined value, decrement the threshold cutoff value to include, in the training, data sets of additional vehicles for which the loss reduction did not exceed the threshold cutoff value prior to decrementing the cutoff value.

8. A method comprising:
receiving a plurality of data sets relating to differently trained versions of a global machine learning model, from a plurality of vehicles, the data sets including at least a present local loss value experienced by a current version of the global model executing on a given vehicle for which a data set of the plurality of data sets was received;
determining a loss reduction for each received data set of the plurality of data sets, representing a loss reduction since a previous local loss value included in a previous received data set corresponding to the given vehicle;
determining whether the loss reduction for each received data set of the plurality of data sets exceeds a predefined threshold cutoff value; and
training the global model using federated learning and based on the data sets of the plurality of data sets for which the loss reduction exceeds the predefined cutoff value.

9. The method of claim 8, wherein the loss reduction is an average loss reduction over a plurality of reporting cycles, wherein a reporting cycle represents an iteration of the data set, including the present local loss value, received for the given vehicle.

10. The method of claim 8, further comprising:
setting a mask vector for each vehicle of the plurality of vehicles for which the loss reduction does not exceed the predefined cutoff value; and
wherein the training is based on the received plurality of data sets modified by the mask vector, such that data sets from each vehicle for which the loss reduction does not exceed the predefined cutoff value are masked out when training the global model.

11. The method of claim 8, further comprising waiting for all of the plurality of vehicles to complete at least one reporting cycle since a prior reporting cycle before training the global model, wherein a reporting cycle represents an iteration of the data set, including the present local loss value, received for the given vehicle.

12. The method of claim 8, further comprising waiting for at least one of a predefined total number or percentage of the plurality of vehicles to complete at least one reporting cycle since a prior reporting cycle before training the global model, wherein a reporting cycle represents an iteration of the data set, including the present local loss value, received for the given vehicle.

13. The method of claim 12, further comprising:
determining whether at least one of a total number or percentage of vehicles for which the loss reduction exceeds the predefined threshold cutoff value exceeds a predefined value representing sufficient training data; and
responsive to the at least one of the total number or percentage not exceeding the predefined value, waiting for data sets to be received from an additional number or additional percentage of the plurality of vehicles.

14. The method of claim 8, further comprising:
determining whether at least one of a total number or percentage of vehicles for which the loss reduction exceeds the predefined threshold cutoff value exceeds a predefined value representing sufficient training data; and
responsive to the at least one of the total number or percentage not exceeding the predefined value, decrementing the threshold cutoff value to include, in the training, data sets of additional vehicles for which the loss reduction did not exceed the threshold cutoff value prior to decrementing the cutoff value.

15. A non-transitory storage medium, storing instructions that, when executed by one or more processors, cause the one or more processors to perform a method comprising:
receiving a plurality of data sets relating to differently trained versions of a global machine learning model, from a plurality of vehicles, the data sets including at least a present local loss value experienced by a current version of the global model executing on a given vehicle for which a data set of the plurality of data sets was received;
determining a loss reduction for each received data set of the plurality of data sets, representing a loss reduction since a previous local loss value included in a previous received data set corresponding to the given vehicle;
determining whether the loss reduction for each received data set of the plurality of data sets exceeds a predefined threshold cutoff value; and
training the global model using federated learning and based on the data sets of the plurality of data sets for which the loss reduction exceeds the predefined cutoff value.

16. The storage medium of claim 15, wherein the loss reduction is an average loss reduction over a plurality of reporting cycles, wherein a reporting cycle represents an iteration of the data set, including the present local loss value, received for the given vehicle.

17. The storage medium of claim 15, the method further comprising:
setting a mask vector for each vehicle of the plurality of vehicles for which the loss reduction does not exceed the predefined cutoff value; and
wherein the training is based on the received plurality of data sets modified by the mask vector, such that data sets from each vehicle for which the loss reduction does not exceed the predefined cutoff value are masked out when training the global model.

18. The storage medium of claim 15, the method further comprising waiting for at least one of a predefined total number or percentage of the plurality of vehicles to complete at least one reporting cycle since a prior reporting cycle before training the global model, wherein a reporting cycle represents an iteration of the data set, including the present local loss value, received for the given vehicle.

19. The storage medium of claim 18, the method further comprising:
determining whether at least one of a total number or percentage of vehicles for which the loss reduction exceeds the predefined threshold cutoff value exceeds a predefined value representing sufficient training data; and
responsive to the at least one of the total number or percentage not exceeding the predefined value, waiting for data sets to be received from an additional number or additional percentage of the plurality of vehicles.

20. The storage medium of claim 15, the method further comprising:
determining whether at least one of a total number or percentage of vehicles for which the loss reduction exceeds the predefined threshold cutoff value exceeds a predefined value representing sufficient training data; and
responsive to the at least one of the total number or percentage not exceeding the predefined value, decrementing the threshold cutoff value to include, in the training, data sets of additional vehicles for which the loss reduction did not exceed the threshold cutoff value prior to decrementing the cutoff value.
